(19) United States
(12) Patent Application Publication
(10) Pub. No.: US 2009/0103037 A1
(43) Pub. Date: Apr. 23, 2009

(54) Display Device

(76) Inventors: Hiroyuki Abe, Chiba (JP); Yoshiomi Yoshi, Mobara (JP); Katsumi Matsumoto, Mobara (JP); Hiroaki Asuma, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/251,517

(22) Filed: Oct. 15, 2008

(30) Foreign Application Priority Data
Oct. 17, 2007 (JP) 2007-269893

(51) Int. Cl. G02F 1/1345

(52) U.S. Cl. 349/150

(57) ABSTRACT

At least one substrate includes plural pad electrodes at an end of at least one side, each of the plural pad electrodes includes a metal layer formed on the at least one substrate and a transparent conductive film formed on the metal layer, and a flexible wiring board includes a connection electrode mechanically and electrically connected to the transparent conductive film of each of the pad electrodes. Each of the pad electrodes has, on a surface on which the metal layer is formed, a metal-layer removed area in which the metal layer is not formed in a shape of a recess or an opening, the transparent conductive film covers both an area in which the metal layer is formed and the metal-layer removed area and is electrically connected to the metal layer in the area in which the metal layer is formed, and the connection electrode of the flexible wiring board is superimposed on both the metal layer and the metal-layer removed area of the pad electrode.

### CLAIM OF PRIORITY

The present invention claims priority from Japanese application serial No. 2007-269893, filed on Oct. 17, 2007, the content of which is hereby incorporated by reference into this application.

### BACKGROUND OF THE INVENTION

1. Field of the Invention

The present invention relates to a display device and, more particularly, to a display device in which pad electrodes connected to a flexible wiring board are also used as pad electrodes for inspection with which an inspection probe can be brought into contact.

2. Description of the Related Art

A liquid crystal display panel of a TFT system including a thin-film transistor as an active element is used as display devices for a television, a display for PCs, and the like because the liquid crystal display panel can display high-definition images. In particular, a small liquid crystal display device of the TFT system is frequently used as display units of portable apparatuses.

FIG. 13 is a diagram of an example of a liquid crystal display panel in the past. In the figure, SUB1 denotes a first substrate, SUB2 denotes a second substrate, and AR denotes a display area.

To manufacture the liquid crystal display panel in the past shown in FIG. 13, the first substrate (SUB1) on which a pixel electrode, a thin-film transistor, and the like are formed and the second substrate (SUB2) on which a color filter and the like are formed are placed one on top of the other a predetermined space apart from each other. Both the substrates are bonded by a seal material provided in a frame shape near a peripheral portion between the substrates. Liquid crystal is filled into an inner side of the seal material between the substrates from a liquid crystal filling port, which is provided in a part of the seal member, and sealed. Sheet polarizers are bonded to outer sides of both the substrates.

In the liquid crystal display panel in the past shown in FIG. 13, plural pad electrodes (PAD) are formed at an end of one side of the first substrate (SUB1). The pad electrodes (PAD) are connected to connection electrodes corresponding thereto on a flexible wiring board (not shown). Display data, a display control signal, and the like from the outside are inputted via the flexible wiring board.

Further, as shown in FIG. 13, in the liquid crystal display panel in the past, pad electrodes for inspection (KPD) are formed on an inner side of the plural pad electrodes. An inspection probe is brought into contact with the pad electrodes for inspection (KPD) during inspection in a manufacturing process.

FIG. 14 is a plan view of one of the pad electrodes (PAD) shown in FIG. 13. FIG. 15 is a sectional view of a sectional structure taken along a B-B′ cut line shown in FIG. 14.

As shown in FIG. 15, the pad electrode (PAD) includes a metal layer 11 formed on the first substrate (SUB1), a first interlayer insulating layer 16 formed on the metal layer 11, a second interlayer insulating layer 15 formed on the first interlayer insulating layer 16, and a transparent conductive film 12 formed on the second interlayer insulating layer 15.

As shown in FIG. 14, the transparent conductive film 12 is formed to cover the entire metal layer 11 such that a peripheral portion of the transparent conductive film 12 extends beyond the metal layer 11. Reference numeral 11-1 denotes a metal wiring layer connected to the metal layer 11.

The transparent conductive film 12 covers the metal layer 11 in the inside of a contact hole 13 formed in the first interlayer insulating layer 16 and the second interlayer insulating layer 15. Therefore, the transparent conductive film 12 is electrically connected to the metal layer 11 in the contact hole 13 formed in the first interlayer insulating layer 16 and the second interlayer insulating layer 15.

Patent documents described below are related to the present invention.

JP-A-2000-155328 (Patent Document 1)

JP-A-11-305251 (Patent Document 2)

However, in the liquid crystal display panel in the past shown in FIG. 13, since the pad electrodes (PAD) and the pad electrodes for inspection (KPD) are formed in separate places, a rim area (an area indicated by Lb in FIG. 13) is wide.

In the liquid crystal display panel in the past shown in FIG. 13, if the pad electrodes for inspection (KPD) are omitted by using the pad electrodes (PAD) as the pad electrodes for inspection (KPD) as well, as a result, the rim area (the area indicated by Lb in FIG. 13) can be reduced. This makes it possible to realize a further reduction in size of the liquid crystal display panel.

However, as shown in FIG. 15, in the pad electrode (PAD) of the liquid crystal display panel in the past, the transparent conductive film 12 is formed on the metal layer 11 in the inside of the contact hole 13. Therefore, when the pad electrodes (PAD) are also used as the pad electrodes for inspection (KPD), it is anticipated that the transparent conductive film 12 of the pad electrode (PAD) on the metal layer 11 is scratched because the inspection probe comes into contact with the transparent conductive film 12.

When the transparent conductive film 12 is scratched, electrolytic corrosion occurs in the metal layer 11 in a later process (e.g., terminal cleaning).

### SUMMARY OF THE INVENTION

The invention has been devised in order to solve the problems of the related arts. It is an object of the present invention to provide a technique for making it possible to realize a further reduction in size of a display device by using pad electrodes as pad electrodes for inspection as well.

The above-mentioned objects and other objects and new characteristics of the present invention are made apparent by the description of this specification and drawings attached thereto.

An overview of representative inventions among inventions disclosed in this application is briefly explained below.
(1) A display device having:

a display panel including at least one substrate; and

a flexible wiring board fixed to an end of at least one side of the at least one substrate,

the at least one substrate including plural pad electrodes at the end of the at least one side,

each of the plural pad electrodes including:
a metal layer formed on the at least one substrate; and
a transparent conductive film formed on the metal layer, and

the flexible wiring board including a connection electrode mechanically and electrically connected to the transparent conductive film of each of the pad electrodes, wherein

each of the pad electrodes has, on a surface on which the metal layer is formed, a metal-layer removed area in which the metal layer is not formed in a shape of a recess or an opening in a plan view,

the transparent conductive film covers both an area in which the metal layer is formed and the metal-layer removed area and is electrically connected to the metal layer in the area in which the metal layer is formed, and

the connection electrode of the flexible wiring board is superimposed on both the metal layer and the metal-layer removed area of the pad electrode.
(2) In (1), the metal-layer removed area is an opening that is formed in the inside of the metal layer and an entire periphery of which is surrounded by the metal layer.
(3) In (1) or (2), the display device further includes an insulating layer provided between the transparent conductive film and the metal layer,

the insulating layer has a contact hole in the area in which the metal layer is formed, and

the transparent conductive film is electrically connected to the metal layer in the contact hole formed in the insulating layer.
(4) In any one of (1) to (3), the metal-layer removed area is arranged in a position in each of the pad electrodes closer to an outer side of each of the pad electrodes than the center in a direction in which the plural pad electrodes are arranged.
(5) In any one of (1) to (4), a pair of the connection electrodes of the flexible wiring board are mechanically and electrically connected to one of the plural pad electrodes,

one of the pair of the connection electrodes is electrically connected to the transparent conductive film in a portion where the metal layer is formed, and

the other of the pair of the connection electrodes is electrically connected to the transparent conductive film in both the metal-layer removed area and the portion where the metal layer is formed.
(6) In any one of (1) to (4), the connection electrode of the flexible wiring board is mechanically and electrically connected to one of the plural pad electrodes, and

the connection electrode is electrically connected to the transparent conducive film in both the metal-layer removed area and the portion where the metal layer is formed.
(7) In any one of (1) to (6), the display panel is a liquid crystal display panel.

An effect obtained by the representative inventions among the inventions disclosed in this application is briefly explained below.

With the display device according to the present invention, it is possible to realize a further reduction in size by using the pad electrodes as the pad electrodes for inspection as well.

### BRIEF DESCRIPTION OF THE DRAWINGS

FIGS. 1A and 1B are diagrams of a liquid crystal display panel according to an embodiment of the present invention;

FIG. 2 is a plan view of a pad electrode (PAD) according to the embodiment;

FIG. 3 is a sectional view of a sectional structure taken along an A-A′ cut line shown in FIG. 2;

FIG. 4 is a plan view of a pad electrode (PAD) according to a modification of the embodiment;

FIG. 5 is a plan view of the pad electrode (PAD) according to the modification;

FIG. 6 is a plan view of an example of a state in which a flexible wiring board is mounted on a first substrate according to the embodiment;

FIG. 7 is a diagram of an example of connection electrodes formed on the flexible wiring board in the embodiment;

FIG. 8 is a main part sectional view of a sectional structure of an example of the state in which the flexible wiring board is mounted on the first substrate according to the embodiment;

FIG. 9 is a plan view of another example of the state in which the flexible wiring board is mounted on the first substrate according to the embodiment;

FIG. 10 is a diagram of another example of the connection electrodes formed on the flexible wiring board in the embodiment;

FIG. 11 is a main part sectional view of a sectional structure of the other example of the state in which the flexible wiring board is mounted on the first substrate according to the embodiment;

FIGS. 12A and 12B are diagrams of a liquid crystal display panel according to a modification of the embodiment;

FIG. 13 is a diagram of an example of a liquid crystal display panel in the past;

FIG. 14 is a plan view of a pad electrode (PAD) shown in FIG. 13; and

FIG. 15 is a sectional view of a sectional structure taken along a B-B′ cut line shown in FIG. 14.

### DETAILED DESCRIPTION OF THE INVENTION

An embodiment of the present invention is explained in detail below with reference to the accompanying drawings.

In all diagrams for explaining the embodiment, components having identical functions are denoted by the same reference numerals and signs and redundant explanation of the components is omitted.

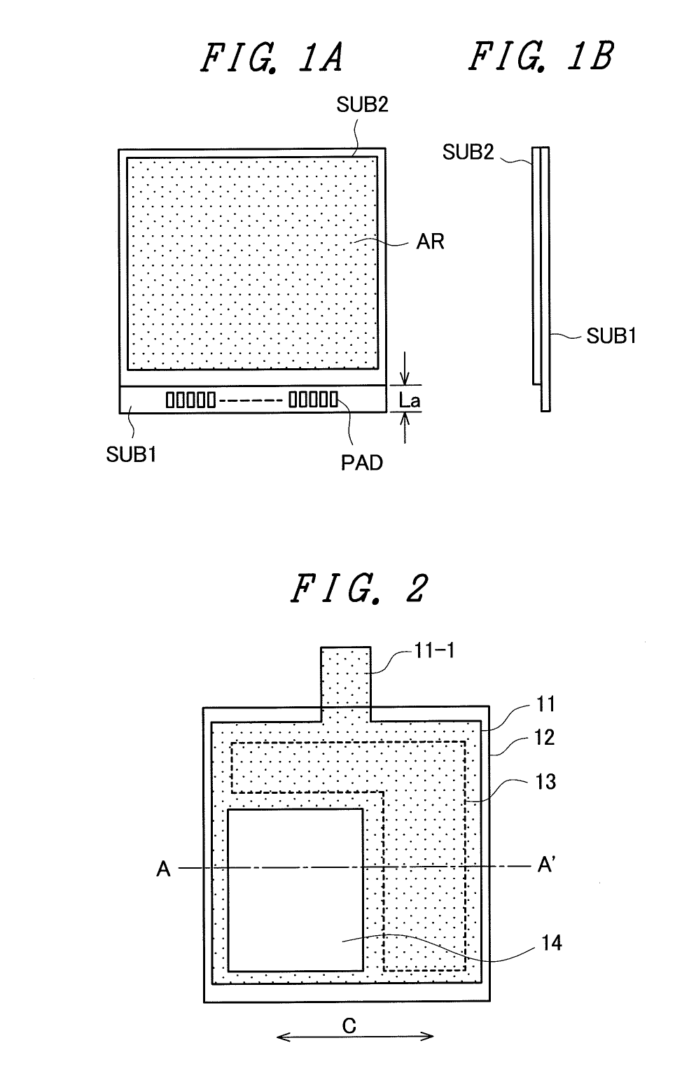

FIGS. 1A and 1B are diagrams of a schematic configuration of a liquid crystal display panel according to this embodiment. FIG. 1A is a front view and FIG. 1B is a side view of the liquid crystal display panel.

In FIGS. 1A and 1B, SUB1 denotes a first substrate made of a glass substrate or the like, SUB2 denotes a second substrate made of a glass substrate or the like, and AR denotes a display area.

To manufacture the liquid crystal display panel according to this embodiment, the first substrate (SUB1) on which a pixel electrode, a thin-film transistor (an active element), and the like are formed and the second substrate (SUB2) on which a color filter and the like are formed are placed one on top of the other a predetermined space apart from each other. Both the substrates are bonded by a seal material provided in a frame shape near a peripheral portion between the substrates. Liquid crystal is filled into an inner side of the seal material between the substrates from a liquid crystal filling port, which is provided in a part of the seal member, and sealed. Sheet polarizers are bonded to outer sides of both the substrates.

A counter electrode is provided on the second substrate (SUB2) side when the liquid crystal display panel is a liquid crystal display panel of a TN system or a VA system. In the case of an IPS system, the counter electrode is provided on the first substrate (SUB1) side. Since the present invention is not related to an internal structure of the liquid crystal display panel, detailed explanation of the internal structure of the liquid crystal display panel is omitted. The present invention can be applied to a liquid crystal display panel having any structure.

In the liquid crystal display panel, in an area surrounded by two adjacent scanning lines (also referred to as gate lines) and two adjacent video lines (also referred to as source lines or drain lines), a thin-film transistor that is turned on by a scanning signal from the scanning lines and a pixel electrode to which a video signal is supplied from the video lines via the thin-film transistor are formed, whereby a so-called pixel is formed.

An area in which a plurality of the pixels are formed is a display area (AR). A peripheral area is present to surround the display area.

In the peripheral area, a video driving circuit that supplies video voltage (a video signal) to the video lines, a scanning line driving circuit that supplies scanning voltage (a scanning signal) to the scanning lines, and a display control circuit that controls and drives the video driving circuit and the scanning line driving circuit are arranged.

In this embodiment, the thin-film transistor (the active element) formed on the first substrate (SUB1) includes a polysilicon thin-film transistor in which low-temperature polysilicon is used as a semiconductor layer.

Similarly, the video driving circuit, the scanning line driving circuit, and the display control circuit also include polysilicon thin-film transistors. The video driving circuit, the scanning line driving circuit, and the display control circuit are arranged in a peripheral portion of the inside of the liquid crystal display panel (i.e., the inside of the first substrate (SUB1) and the second substrate (SUB2) sealed by the seal material).

In the liquid crystal display panel according to this embodiment, since the pad electrodes (PAD) are also used as the pad electrodes for inspection (KPD), plural pad electrodes (PAD) are formed at an end of one side of the first substrate (SUB1) but the pad electrodes for inspection (KPD) shown in FIG. 13 are not formed.

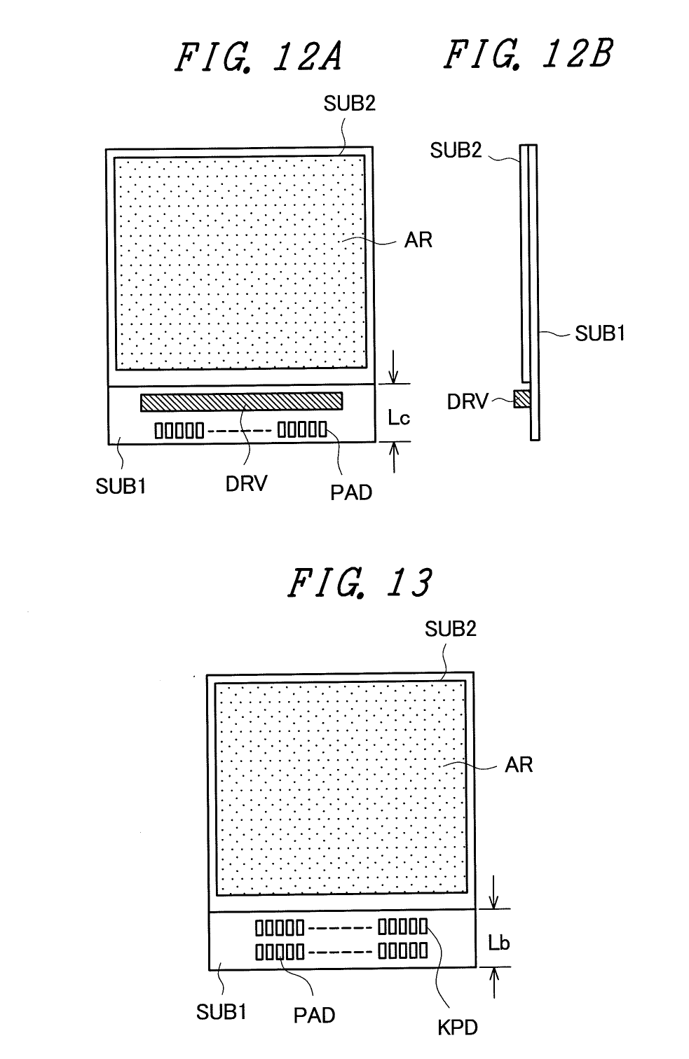

In FIGS. 1A and 12, the plural pad electrodes (PAD) are formed at the end of one side of the rectangular first substrate (SUB1). However, the plural pad electrodes (PAD) may be formed at ends of two sides, ends of three sides, or ends of all sides of the first substrate (SUB1).

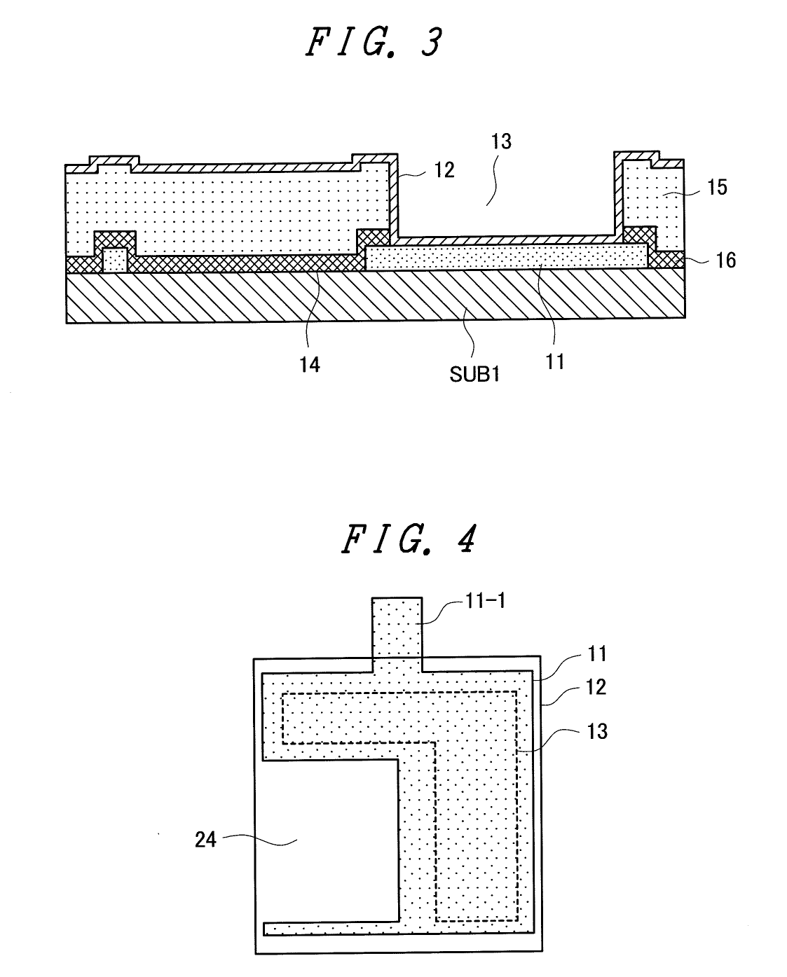

FIG. 2 is a plan view of the pad electrode (PAD) according to this embodiment. FIG. 3 is a sectional view of a sectional structure taken along an A-A cut line shown in FIG. 2.

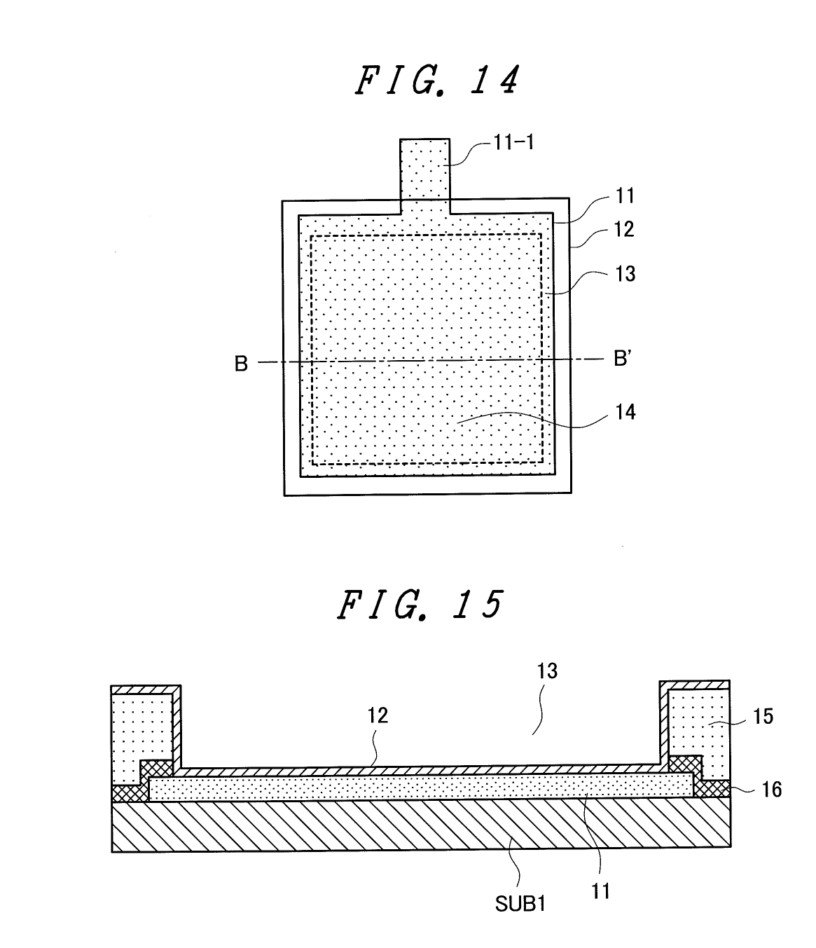

The pad electrode (PAD) according to this embodiment is different from the pad electrode in the past shown in FIGS. 14 and 15 in that an opening 14 is formed in the metal layer 11 of the pad electrode (PAD) and that the contact hole 13 formed in the first interlayer insulating layer 16 and the second interlayer insulating layer 15 is formed in an L shape to avoid the opening 14. In FIG. 2, reference numeral 11-1 denotes a metal wiring layer connected to the metal layer 11.

As described above, in this embodiment, a metal-layer removed area (the area of the opening 14) in which a metal layer is not formed is formed on a surface on which the metal layer 11 is formed. The opening 14 is a portion with which an inspection probe is brought into contact during inspection in a manufacturing process. Therefore, an area of the opening 14 needs to be equal to or larger than a minimum area required for bringing the inspection probe into contact therewith.

In this way, in each of the pad electrodes (PAD) according to this embodiment, the metal layer 11 is not formed in the portion with which the inspection probe is brought into contact during inspection in the manufacturing process. Therefore, in this embodiment, even if the transparent conductive film 12 of each of the pad electrodes (PAD) is scratched by the contact of the inspection probe during inspection in the manufacturing process, electrolytic corrosion does not occur in the metal layer 11 in a later process (e.g., terminal cleaning).

Consequently, in this embodiment, since it is unnecessary to provide the pad electrodes for inspection (KPD) in a place separate from the pad electrodes (PAD), it is possible to set the rim area (the area indicated by La in FIG. 1A) shorter than that in the past. This makes it possible to realize a further reduction in size of the liquid crystal display panel.

In this embodiment, the contact hole 13 is formed in an L shape to avoid the opening 14. The transparent conductive film 12 and the metal layer 11 are electrically connected in the inside of the contact hole 13.

The opening 14 is arranged in a position in each of the pad electrodes (PAD) closer to an outer side of each of the pad electrodes (PAD) than the center in a direction in which the plural pad electrodes (PAD) are arranged (a direction indicated by an arrow C in FIG. 2).

In this embodiment, the first interlayer insulating layer 16 and the second interlayer insulating layer 15 are formed between the transparent conductive film 12 and the opening 14. However, the first interlayer insulating layer 16 and the second interlayer insulating layer 15 between the transparent conductive film 12 and the opening 14 can be omitted.

In this embodiment, indium tin oxide (ITO) is used for the transparent conductive film 12. However, transparent conductive films of zinc oxide and tin oxide can also be used. In this embodiment, a metal layer formed by stacking three layers of MoW, AlSi, and MoW is used as the metal layer 11. However, well-known metal materials used in display devices and semiconductor techniques can also be used.

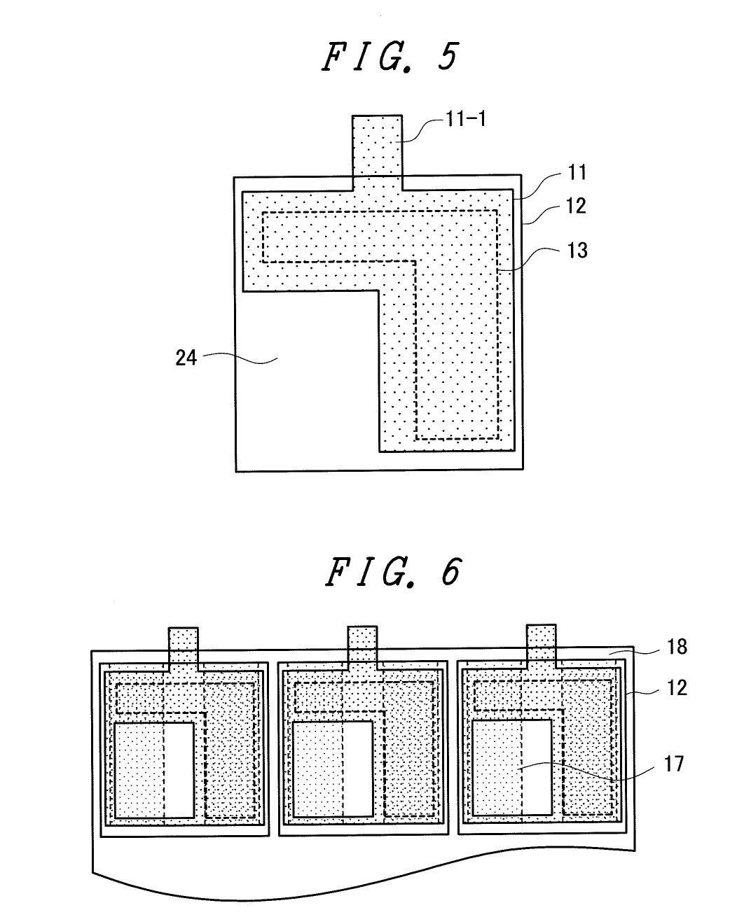

Moreover, in the above explanation, the opening 14 is formed in the metal layer 11, whereby the metal-layer removed area in which the metal layer is not formed is formed on the surface on which the metal layer 11 is formed. Besides this structure, for example, as shown in FIG. 4, a recess 24 may be formed in a part of the metal layer 11. Alternatively, as shown in FIG. 5, the metal layer 11 may be formed in an L shape to form the metal-layer removed area. In the case of FIG. 5, as in the case of FIG. 4, the metal-layer removed area is formed in a shape of the recess 24 in a plan view in a part of the metal layer 11.

In this embodiment, display data or a display control signal from a display signal source (a host side) is inputted to the liquid crystal display panel via the flexible wiring board.

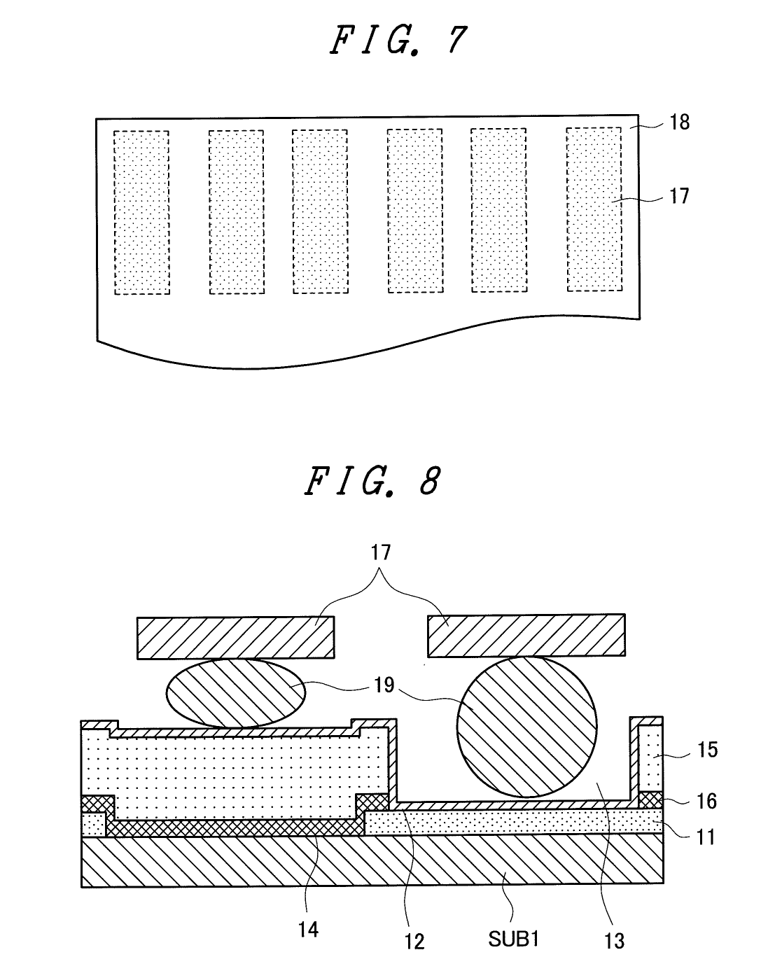

FIG. 6 is a plan view of an example of a state in which a flexible wiring board 18 is mounted on the first substrate (SUB1) according to this embodiment. FIG. 7 is a diagram of an example of connection electrodes 17 formed on the flexible wiring board 18. FIG. 8 is a main part sectional view of a sectional structure of an example of the state in which the flexible wiring board 18 is mounted on the first substrate (SUB1) according to this embodiment.

In FIGS. 6 to 8, two connection electrodes 17 are mechanically and electrically connected to one pad electrode (PAD). In FIGS. 6 to 8, to simplify the illustration, three pad electrodes (PAD) are shown. However, it goes without saying that, actually, three or more pad electrodes (PAD) are arranged.

In FIGS. 6 to 8, two connection electrodes 17 are mechanically and electrically connected to one pad electrode (PAD). One of the two connection electrodes 17 is electrically connected to the transparent conductive film 12 via a conductive particle 19 in the portion where the metal layer 11 is formed. The other of the two connection electrodes 17 is electrically connected to the transparent conductive film 12 via the conductive particles 19 in both the opening 14 (the metal-layer removed area) and the portion where the metal layer 11 is formed.

Therefore, as shown in FIG. 8, the conductive particle 19 in the portion of the opening 14 (the metal-layer removed area) is substantially deformed.

It goes without saying that identical voltage (or an identical signal) is supplied to the two connection electrodes 17 mechanically and electrically connected to the one pad electrode (PAD).

The metal-layer removed area may be formed in the shape of the recess 24 explained with reference to FIGS. 4 and 5 instead of the shape of the opening 14, the entire periphery of which is surrounded by the metal layer 11.

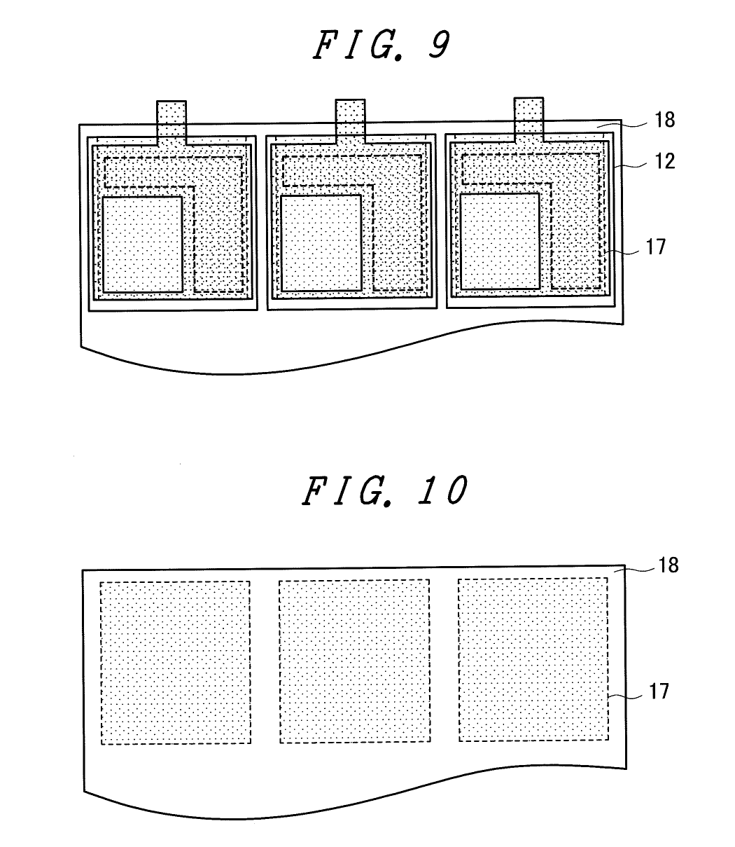

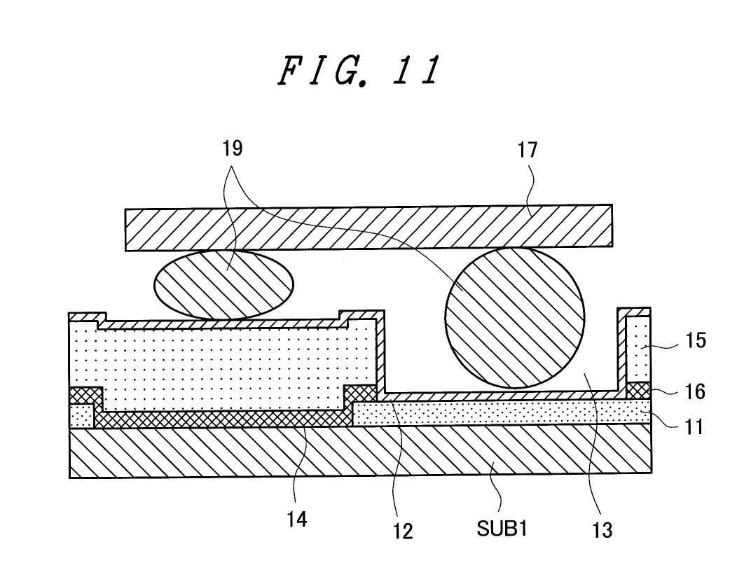

FIG. 9 is a plan view of another example of the state in which the flexible wiring board 18 is mounted on the first substrate (SUB1) according to this embodiment. FIG. 10 is a diagram of another example of the connection electrodes 17 formed on the flexible wiring board 18. FIG. 11 is a main part sectional view of a sectional structure of another example of the state in which the flexible wiring board 18 is mounted on the first substrate (SUB1) according to this embodiment.

In FIGS. 9 to 11, one connection electrode 17 is mechanically and electrically connected to one pad electrode (PAD). In FIGS. 9 to 11, as in FIGS. 6 to 8, to simplify the illustration, three pad electrodes (PAD) are shown. However, it goes without saying that, actually, three or more pad electrodes (PAD) are arranged.

In FIGS. 9 to 11, one connection electrode 17 is electrically connected to the transparent conductive film 12 via the conductive particles 19 in both the opening 14 (the metal-layer removed area) and the portion where the metal layer 11 is formed.

Therefore, as shown in FIG. 11, the conductive particle 19 in the portion of the opening 14 (the metal-layer removed area) is substantially deformed.

The metal-layer removed area may be formed in the shape of the recess 24 explained with reference to FIGS. 4 and 5 instead of the shape of the opening 14, the entire periphery of which is surrounded by the metal layer 11.

As explained with reference to FIGS. 6 to 11, rather than configuring the pad electrode (PAD) with only the transparent conductive film 12, the metal layer 11 is left in a part of the pad electrode (PAD) and the connection electrode 17 of the flexible wiring board 18 is superimposed on both the metal-layer removed area and the metal layer 11. This makes it possible to reduce electrical connection resistance.

FIGS. 12A and 12B are diagrams of a liquid crystal display panel according to a modification of this embodiment.

In the liquid crystal display panel shown in FIGS. 12A and 12B, a semiconductor chip (DRV) mounted with a video driving circuit that supplies video voltage to video lines, a scanning line driving circuit that supplies scanning voltage to scanning lines, and a display control circuit that controls and drives the video driving circuit and the scanning line driving circuit is mounted on the first substrate (SUB1) by a COG system. FIG. 12A is a front view and FIG. 12B is a side view of the liquid crystal display panel.

In the above explanation, the polysilicon thin-film transistor in which the low-temperature polysilicon is used as the semiconductor layer is used as the thin-film transistor (the active element) formed on the first substrate (SUB1). However, an amorphous silicon thin-film transistor in which amorphous silicon is used as a semiconductor layer may be used as the thin-film transistor (the active element) formed on the first substrate (SUB1).

As explained above, in this embodiment, the metal layer 11 is not formed in the portion with which the inspection probe is brought into contact during inspection in the manufacturing process. Therefore, even if the transparent conductive film 12 of each of the pad electrodes (PAD) is scratched by the contact of the inspection probe during inspection in the manufacturing process, electrolytic corrosion does not occur in the metal layer 11 in a later process (e.g., terminal cleaning).

Consequently, in this embodiment, since it is unnecessary to provide the pad electrodes for inspection (KPD) in a place separate from the pad electrodes (PAD), it is possible to set a rim area (an area indicated by Lc in FIG. 12A) shorter than that in the past. This makes it possible to realize a further reduction in size of the liquid crystal display panel.

In Patent Document 1, a technique for removing a metal layer lower than a transparent conductive film in a pad electrode for inspection is described. However, in Patent Document 1, it is evident that bypass wiring is formed near the pad electrode for inspection and a pad electrode for connection to the outside is formed in a separate place. It is not described in Patent Document 1 that a pad electrode is also used as the pad electrode for inspection.

In Patent Document 2, a technique for forming a pad electrode for inspection near a pad electrode connected to a bump electrode of a semiconductor chip is described. However, in Patent Document 2, the pad electrode for inspection is not superimposed on the bump electrode of the semiconductor chip. Moreover, the pad electrode described in Cited Document 2 is not connected to a connection electrode of a flexible wiring board. Therefore, it is not described in Patent Document 2 that the pad electrode connected to the connection electrode of the flexible wiring board is also used as the pad electrode for inspection.

In the embodiment explained above, the present invention is applied the liquid crystal display device. However, the present invention is not limited to this. The present invention can be applied to all display devices having pixels such as an organic EL display device. Therefore, two substrates do not always have to be used for a display panel. At least one substrate only has to be used for the display panel.

The invention devised by the inventor is specifically explained above on the basis of the embodiment. However, the present invention is not limited to the embodiment. It goes without saying that various alterations are possible without departing from the spirit of the present invention.

What is claimed is:

1. A display device comprising:
a display panel including at least one substrate; and
a flexible wiring board fixed to an end of at least one side of the at least one substrate,
the at least one substrate including plural pad electrodes at the end of the at least one side,
each of the plural pad electrodes including:
a metal layer formed on the at least one substrate; and
a transparent conductive film formed on the metal layer, and
the flexible wiring board including a connection electrode mechanically and electrically connected to the transparent conductive film of each of the pad electrodes, wherein
each of the pad electrodes has, on a surface on which the metal layer is formed, a metal-layer removed area in which the metal layer is not formed in a shape of a recess or an opening,
the transparent conductive film covers both an area in which the metal layer is formed and the metal-layer removed area and is electrically connected to the metal layer in the area in which the metal layer is formed, and
the connection electrode of the flexible wiring board is superimposed on both the metal layer and the metal-layer removed area of the pad electrode.

2. A display device according to claim 1, wherein the metal-layer removed area is an opening that is formed in the inside of the metal layer and an entire periphery of which is surrounded by the metal layer.

3. A display device according to claim 2, further comprising an insulating layer provided between the transparent conductive film and the metal layer, wherein
the insulating layer has a contact hole in the area in which the metal layer is formed, and
the transparent conductive film is electrically connected to the metal layer in the contact hole formed in the insulating layer.

4. A display device according to claim 3, wherein the metal-layer removed area is arranged in a position in each of the pad electrodes closer to an outer side of each of the pad electrodes than a center in a direction in which the plural pad electrodes are arranged.

5. A display device according to claim 4, wherein
a pair of the connection electrodes of the flexible wiring board are mechanically and electrically connected to one of the plural pad electrodes,
one of the pair of the connection electrodes is electrically connected to the transparent conductive film in a portion where the metal layer is formed, and
the other of the pair of the connection electrodes is electrically connected to the transparent conductive film in both the metal-layer removed area and the portion where the metal layer is formed.

6. A display device according to claim 4, wherein
a singularity of the connection electrode of the flexible wiring board is mechanically and electrically connected to one of the plural pad electrodes, and
the singularity of the connection electrode is electrically connected to the transparent conducive film in both the metal-layer removed area and the portion where the metal layer is formed.

7. A display device according to claim 6, wherein the display panel is a liquid crystal display panel.
